(19) United States
(12) Patent Application Publication
(10) Pub. No.: US 2026/0264739 A1
(43) Pub. Date: Sep. 10, 2026

(54) DRIVING OPERATION APPARATUS FOR VEHICLE AND OPERATING METHOD THEREOF

(71) Applicants: Hyundai Motor Company, Seoul (KR); Kia Corporation, Seoul (KR); LS Automotive Technologies Co., Ltd., Anyang-si (KR)

(72) Inventors: Eun Sik KIM, Hwaseong-si (KR); Hun JUNG, Anyang-si (KR); Ki Nyeong KO, Anyang-si (KR); Jung Jae LEE, Anyang-si (KR)

(73) Assignees: Hyundai Motor Company, Seoul (KR); Kia Corporation, Seoul (KR); LS Automotive Technologies Co., Ltd., Anyang-si (KR)

(21) Appl. No.: 19/319,585

(22) Filed: Sep. 4, 2025

(30) Foreign Application Priority Data
Mar. 4, 2025 (KR) 10-2025-0027508

(51) Int. Cl. B62D 1/183; B62D 1/04

(52) U.S. Cl. CPC B62D 1/183; B62D 1/046

(57) ABSTRACT

Disclosed are a driving operation apparatus for a vehicle and an operating method thereof, which provide a modular configuration in which a driving operation system for steering, acceleration, and braking is integrated with a display portion into a single system, and which allows the driving operation system to be hidden in an autonomous driving mode, preventing operation by a driver, and to be popped up in a manual driving mode, enabling operation by the driver. This contributes to weight reduction and cost savings by reducing the number of components, enabling greater efficiency in utilizing the internal space.

### CROSS-REFERENCE TO RELATED APPLICATION

The present application claims priority of Korean Patent Application No. 10-2025-0027508 filed on Mar. 4, 2025, the entire contents of which are incorporated herein for all purposes by this reference.

### BACKGROUND OF THE DISCLOSURE

### Field of the Disclosure

Exemplary embodiments of the present disclosure relate to a driving operation apparatus for a vehicle and an operating method thereof, and more particularly, to a driving operation apparatus for a vehicle and an operating method thereof, in which a driving operation system for steering, acceleration, and braking is integrated into a single system with a display portion to form a modular structure, and the driving operation system is hidden and popped up depending on autonomous driving mode and manual driving mode.

### Description of the Related Art

An autonomous vehicle is a smart vehicle equipped with autonomous driving technology, allowing travel to the destination without a driver manually operating the steering wheel, accelerator pedal, or brakes.

When autonomous driving becomes widespread, the driver may select between manual driving mode in which the driver manually drives the vehicle, and autonomous driving mode in which the vehicle independently travels to the destination without the driver manually driving the vehicle.

A driving operation system of an autonomous vehicle may typically include a steering operation system, an acceleration operation system, and a braking operation system. In a conventional driving operation system, these steering, acceleration, and braking operation systems are individually configured, resulting in a large number of components. The present configuration requires separate installation spaces, leading to spatial constraints, and may increase costs.

Furthermore, the conventional driving operation system is exposed within the cabin in an autonomous driving mode, which may cause discomfort for passengers.

The above description of the related art is intended to provide a better understanding of the background of the present disclosure and should not be taken as an admission of related art known to those of ordinary skill in the art.

### SUMMARY OF THE DISCLOSURE

The present disclosure is directed to providing a modularized driving operation apparatus for a vehicle in which a driving operation system for steering, acceleration, and braking is integrated into a single system with a display portion, and an operating method thereof. This contributes to weight reduction and cost savings by reducing the number of components, and allows for the compact layout required for installation space, enabling greater efficiency in utilizing the internal space.

The present disclosure is directed to providing a configuration allowing the driving operation system for steering, acceleration, and braking to be hidden in an autonomous driving mode, which prevents operation by a driver, and to be popped up in a manual driving mode, which enables operation by the driver. The present configuration allows comfortable rest for the driver in autonomous driving situations and improves safety by preventing accidental operation.

Furthermore, the present disclosure is directed to providing a configuration including an integrated display that delivers enhanced entertainment for passengers in an autonomous driving mode and provides vehicle and environmental information in a manual driving mode, which improves convenience and safety.

The technical problems included in the present disclosure are not limited to the aforementioned technical problems, and other unmentioned technical problems will be clearly appreciated by those skilled in the art from the description below.

A driving operation apparatus for a vehicle according to an exemplary embodiment of the present disclosure includes a rotation housing, wherein a center shaft fixed to a vehicle mounting portion passes through the rotation housing and the rotation housing is configured to rotate about the center shaft during steering operation, a fixed housing coupled to and fixed with the center shaft, a display portion coupled to the fixed housing, and a pair of driving operation systems rotatably disposed relative to the rotation housing and configured to be inserted and concealed within the fixed housing through a hide operation in an autonomous driving mode, and protrude toward a driver from right and left sides of the display portion through a pop-up operation in a manual driving mode, which enables steering, acceleration, and braking operations by the driver in a popped-up state.

A housing insertion portion is disposed in a center portion of the rotation housing, and the fixed housing is inserted into the housing insertion portion and coupled with the center shaft.

The rotation housing includes rotation grooves that allow a rotation of the driving operation system and are connected to the housing insertion portion on right and left sides of the housing insertion portion, and the rotation grooves are formed at a position spaced upward or downward from the center shaft.

The fixed housing includes an operation system insertion portion into which the driving operation system is inserted in an autonomous driving mode, and connection grooves are formed on the right and left sides of the operation system insertion portion to connect the operation system insertion portion with the rotation grooves.

The display portion is configured to rotate vertically relative to the fixed housing, and in response to the display portion rotating in a first direction, the operation system insertion portion is opened, and in response to the display portion rotating in a second direction, the operation system insertion portion is closed by the display portion.

The driving operation apparatus further includes a first motor fixed to the fixed housing and connected to the display portion to enable power transmission. In response to an operation of the first motor, the display portion rotates vertically relative to the fixed housing.

The driving operation apparatus further includes a second motor fixed to the rotation housing and connected to an end portion of the driving operation system to enable power transmission. In response to an operation of the second motor, the driving operation system rotates to be hidden or popped up.

The driving operation system includes a body portion at an end, which is positioned within the rotation housing and coupled with the second motor, a handle portion at an opposite end portion that the driver grips with a hand to perform the steering operation by rotating the rotation housing clockwise or counterclockwise, and a connection portion connecting the body portion and the handle portion, wherein the handle portion is configured to protrude toward the driver in the pop-up operation.

The driving operation system further includes an acceleration operation system and a braking operation system, which are positioned between the handle portion and the connection portion and are driven in response to the driver's operation.

The driving operation apparatus further includes a first solenoid fixed to the rotation housing and having a first rod that moves back and forth during operation thereof, wherein the driving operation system is formed with a first stopper groove into which the first rod is inserted, the first rod moves forward and is inserted into the first stopper groove in a state where the driving operation system is popped up, and in response to the insertion of the first rod into the first stopper groove, a position of the driving operation system is fixed in the popped-up state, thus restricting rotation.

The first stopper groove includes a first groove, a second groove, and a third groove, disposed to extend along a rotation direction of the driving operation system, wherein the first groove is positioned in the center, and the second groove and the third groove are positioned to the left and right of the first groove, and the left and right sides of the first groove are partially overlapped with a side of the second groove and a side of the third groove, respectively.

In response to the insertion of the first rod into the first groove, the popped-up right and left driving operation systems have the connection portion protruding perpendicularly from a surface of the display portion, and the right and left handle portions are spaced by a first distance. In response to the insertion of the first rod into the second groove, the popped-up right and left driving operation systems have the connection portion protruding at an acute angle from a surface of the display portion, and the right and left handle portions are spaced by a second distance, narrower than the first distance. In response to the insertion of the first rod into the third groove, the popped-up right and left driving operation systems have the connection portion protruding at an obtuse angle from a surface of the display portion, and the right and left handle portions are spaced by a third distance, wider than the first distance.

The vehicle mounting portion includes an arc seating portion into which a portion of the rotation housing is inserted and which allows clockwise and counterclockwise rotation of the rotation housing during steering operation, and further includes a second solenoid fixed to the arc seating portion and having a second rod that moves back and forth during operation thereof, wherein the rotation housing includes a second stopper groove into which the second rod is inserted, the second rod moves forward and is inserted into the second stopper groove in response to a signal generated for transition from an autonomous driving mode to a manual driving mode, and following the insertion of the second rod into the second stopper groove, an operation of the second motor causes the driving operation system to change from the hidden state to the popped-up state.

The driving operation systems are disposed side by side on the right and left as viewed from the driver's side in the hidden state, and the connection portion and the handle portion are configured to form an L-shape, and the operation system insertion portion and the connection groove, which are formed in the fixed housing to allow the insertion of the right and left driving operation systems, are configured to connect in a T-shape as viewed from the driver's side.

In response to the driving operation system changing from the hidden state to the popped-up state and a transition to manual driving mode being complete, the second rod moves backward and detaches from the second stopper groove, and the rotation housing rotates clockwise or counterclockwise relative to the vehicle mounting portion during steering operation.

The second rod moves forward and is inserted into the second stopper groove in response to a signal generated for transition from manual driving mode to autonomous driving mode, and following the insertion of the second rod into the second stopper groove, an operation of the second motor causes the driving operation system to change from the popped-up state to the hidden state, and in response to the completion of a transition to autonomous driving mode, the second rod either moves backward to detach from the second stopper groove or remains inserted within the second stopper groove.

The driving operation apparatus further includes an operation system control unit, which is disposed in the fixed housing, controls an operation of the first motor, the second motor, the first solenoid, and the second solenoid, and communicates signals related to steering, acceleration, braking, and gear shifting with a vehicle control unit.

An operating method of a driving operation apparatus for a vehicle includes a first pop-up stage, wherein in response to a signal generated for transition from an autonomous driving mode to a manual driving mode, an operation of a first motor causes a display portion to rotate upward relative to a fixed housing and open an operation system insertion portion of a fixed housing, a second pop-up stage, wherein following the completion of the first pop-up stage, a second motor operates, and in response to the operation of the second motor, right and left driving operation systems positioned within the operation system insertion portion rotate outward to the full extent of rotation, which causes both the driving operation systems to pop up, and the pop-up ends with a distance between the right and left driving operation systems becoming wider than a right-left width of the display portion, a third pop-up stage, wherein following the completion of the second pop-up stage, the first motor operates, and in response to the operation of the first motor, the display portion, rotated upward, rotates downward relative to the fixed housing and closes the operation system insertion portion of the fixed housing, and a fourth pop-up stage, wherein following the completion of the third pop-up stage, the second motor operates, and in response to the operation of the second motor, the right and left driving operation systems, popped up by rotating to the full extent of rotation, rotate in an opposite direction to narrow a distance between the driving operation systems, and a position adjustment to a suitable position for manual driving mode is completed in the fourth pop-up stage.

Following the completion of the fourth pop-up stage, an operation of the second motor allows for further adjustment of the distance between the driving operation systems, either in a direction of widening or narrowing.

The operating method further includes a first hide stage, wherein following the completion of the third pop-up stage, the second motor operates in response to a signal generated for transition from manual driving mode to autonomous driving mode, and the operation of the second motor causes the right and left driving operation systems, in the popped-up state, to rotate outward to the full extent of rotation, and a distance between the right and left driving operation systems, rotated outward to the full extent of rotation, becomes wider than a right-left width of the display portion, a second hide stage, wherein following the completion of the first hide stage, an operation of the first motor causes the display portion to rotate upward relative to the fixed housing and open the operation system insertion portion of the fixed housing, a third hide stage, wherein following the completion of the second hide stage, the second motor operates, and in response to the operation of the second motor, the right and left driving operation systems, in the popped-up state, rotate inward and are inserted into the operation system insertion portion, and a fourth hide stage, wherein following the completion of the third hide stage, the first motor operates, and in response to the operation of the first motor, the display portion, rotated upward, rotates downward relative to the fixed housing and closes the operation system insertion portion of the fixed housing.

The driving operation apparatus for a vehicle and the operating method thereof according to an exemplary embodiment of the present disclosure provide a modular configuration in which the driving operation system for steering, acceleration, and braking is integrated with the display portion into a single system. The present configuration contributes to weight reduction and cost savings by reducing the number of components, and allows for the compact layout required for installation space, enabling greater efficiency in utilizing the internal space.

The present disclosure provides a configuration allowing the driving operation system for steering, acceleration, and braking to be hidden in an autonomous driving mode, which prevents operation by the driver, and to be popped up in a manual driving mode, which enables operation by the driver. The present configuration allows comfortable rest for the driver in autonomous driving situations and improves safety by preventing accidental operation.

Furthermore, the present disclosure includes an integrated display that delivers enhanced entertainment for passengers in an autonomous driving mode and provides vehicle and environmental information in a manual driving mode, which improves convenience and safety.

The effects of the present disclosure are not limited to those mentioned above. Other unmentioned effects will be clearly understood by those skilled in the art from the description below.

### BRIEF DESCRIPTION OF THE DRAWINGS

FIG. 1 is a view exemplarily illustrating a state in which a driving operation system is hidden in an autonomous driving mode according to an exemplary embodiment of the present disclosure.

FIG. 2 is a view exemplarily illustrating a state in which the driving operation system is popped up in a manual driving mode.

FIG. 3 is an exploded view of a driving operation apparatus according to according to an exemplary embodiment of the present disclosure.

FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19 and FIG. 20 are views describing components of the driving operation apparatus according to according to an exemplary embodiment of the present disclosure.

FIG. 21, FIG. 22 and FIG. 23 are views describing an operating method of the driving operation apparatus according to according to an exemplary embodiment of the present disclosure. FIG. 21 is a view of an operation process in which the driving operation system changes from the hidden state to the popped-up state, and FIG. 23 is a view of an operation process in which the driving operation system changes from the popped-up state to the hidden state.

### DETAILED DESCRIPTION OF THE DISCLOSURE

In describing embodiments disclosed in the present specification, when a detailed description of a known related art is determined to obscure the gist of the present specification, the detailed description thereof will be omitted herein. Furthermore, the accompanying drawings are merely for easy understanding of the exemplary embodiments disclosed in the present specification, the technical spirit disclosed in the present specification is not limited by the accompanying drawings, and it should be understood to include all modifications, equivalents, and substitutes included in the spirit and scope of the present disclosure.

Terms including ordinal numbers such as first, second, and the like used herein may be used to describe various components, but the various components are not limited by these terms. The terms are used only for the purpose of distinguishing one component from another component.

Unless the context clearly dictates otherwise, the singular form includes the plural form.

In the present specification, the terms “comprising,” “having,” or the like are used to specify that a feature, a number, a step, an operation, a component, an element, or a combination thereof described herein exists, and they do not preclude the possibility of the presence or addition of one or more other features, numbers, steps, operations, components, elements, or combinations thereof.

As used in the following description, suffixes “module” and “part” for a component are used or interchangeably used solely for ease of preparation of the specification, and do not have different meanings and each of them does not function by itself.

When a component is referred to as being “connected” or “coupled” to another component, the component may be directly connected or coupled to another component, but it should be understood that sill another component may be present between the component and another component. Conversely, when a component is referred to as being “directly connected” or “directly coupled” to another component, it should be understood that still another component may not be present between the component and another component.

Furthermore, a unit or control unit included in names such as a motor control unit (MCU) and a hybrid control unit (HCU) is only a term widely used in the naming of a controller that is configured to control the specific function of a vehicle, but does not mean a generic function unit.

A controller may include a communication device for communicating with other control units or sensors to control a responsible function, memory for storing an operating system, a logic command, and input/output information, and one or more processors for performing determination, calculation, and decision which are necessary for controlling the responsible function.

Hereinafter, embodiments included in the present specification will be described in detail with reference to the drawings. The same reference numerals are provided to the same or similar components regardless of reference numerals, and a repetitive description thereof will be omitted.

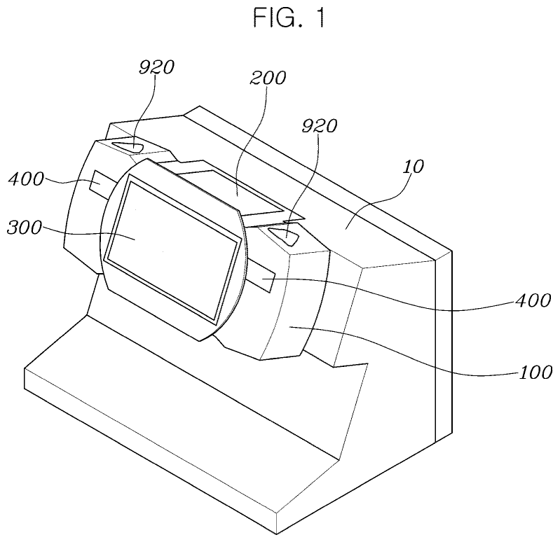

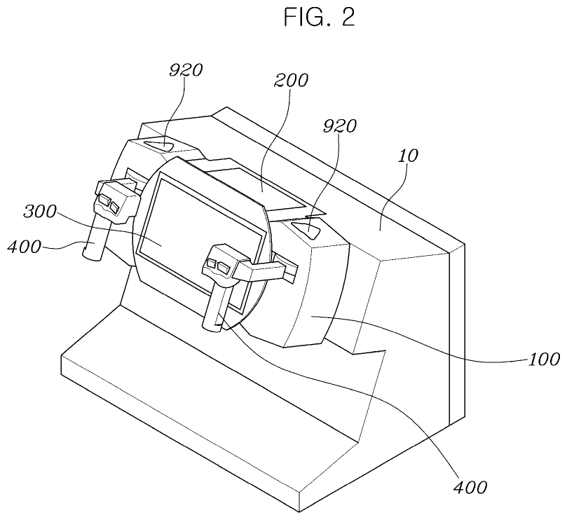

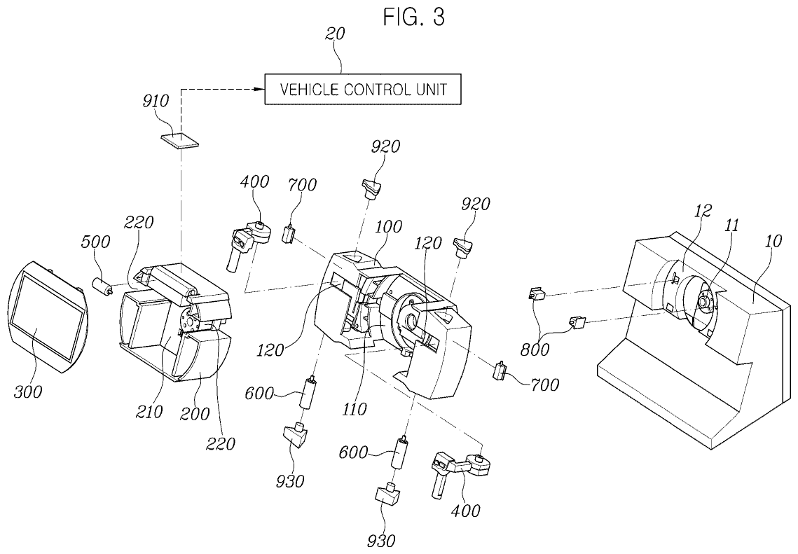

As illustrated in FIGS. 1 to 23, a driving operation apparatus for a vehicle and an operating method thereof according to an exemplary embodiment of the present disclosure may include a rotation housing 100 configured to be passed through by a center shaft 11 fixed to a vehicle mounting portion 10 and rotate about the center shaft 11 during steering operation, a fixed housing 200 configured to be coupled to and fixed with the center shaft 11 passing through the rotation housing 100, a display portion 300 configured to be rotatably coupled to the fixed housing 200, and a pair of driving operation systems 400 rotatably disposed relative to the rotation housing 100 and configured to be inserted and concealed within the fixed housing 200 through a hide operation in an autonomous driving mode, and protrude toward a driver from the right and left sides of the display portion 300 through a pop-up operation in a manual driving mode, which enables steering, acceleration, and braking operations by the driver in the popped-up state.

The vehicle mounting portion 10 may be a crash pad in the vehicle cabin.

The vehicle mounting portion 10 may be provided with the protruding center shaft 11, and the center shaft 11 may pass through the center of the rotation housing 100. Accordingly, the rotation housing 100 may rotate clockwise and counterclockwise about the center shaft 11.

The fixed housing 200 may be overlapped with the rotation housing 100 in the direction facing the driver, and an end portion of the center shaft 11 passing through the rotation housing 100 may be coupled to and integrated with the fixed housing 200.

Accordingly, during steering operation, the vehicle mounting portion 10 and the fixed housing 200 are configured as non-rotating fixed components, and the rotation housing 100 alone may rotate clockwise and counterclockwise.

The rotation housing 100 may be provided with a return spring, and both end portions of the return spring may be configured to be connected to the vehicle mounting portion 10 and the rotation housing 100.

During the driver's steering operation, the rotation housing 100 may rotate clockwise and counterclockwise. This causes the return spring to be compressed. As the driver's steering operation is released, the rotation housing 100 may rotate in the opposite direction due to the spring force of the return spring and return to the neutral position.

The display portion 300 may be rotatably coupled to the front of the fixed housing 200.

An end portion of the driving operation system 400 may be configured to rotate relative to the rotation housing 100 so that during the rotation relative to the rotation housing 100, the driving operation system 400 may be hidden and popped up.

In autonomous driving mode, the driving operation system 400 may be inserted and concealed within the fixed housing 200 through a hide operation. In a manual driving mode, the driving operation system 400 may be exposed to allow protrusion toward the driver through a pop-up operation.

The driving operation system 400 may include two separate components with the same configuration and be disposed in a symmetrical structure on the right and left sides of the display portion 300. The driving operation systems 400 on the right and left sides may be operated by the driver using the right and left hands.

The driver may use the driving operation system 400 to enable steering, acceleration, and braking operations of the vehicle, and shifting operations may also be performed as needed.

A housing insertion portion 110 of a predetermined size may be disposed in a center portion of the rotation housing 100, and the fixed housing 200 may be inserted into the housing insertion portion 110 and coupled with the center shaft 11.

The rotation housing 100 may be provided with rotation grooves 120 that allow the rotation of the driving operation system 400, which are formed on the right and left sides of the housing insertion portion 110 to connect with the housing insertion portion 110.

The rotation groove 120 may be formed to extend laterally on the right and left sides of the housing insertion portion 110 and include an end portion connected to the housing insertion portion 110.

During the rotation of the driving operation system 400 relative to the rotation housing 100, a connection portion 430 of the driving operation system 400 may move along the rotation groove 120 so that the rotation groove 120 is configured to allow the rotation of the driving operation system 400.

In a structure that the center shaft 11 of the vehicle mounting portion 10 passes through the center of the rotation housing 100, the rotation groove 120 may be formed at a position spaced upward or downward from the center shaft 11.

For example, if the rotation groove 120 is located at a position spaced downward from the center shaft 11, a handle portion 420 of the driving operation system 400 may be configured to extend upward from the connection portion 430, and if the rotation groove 120 is located at a position spaced upward from the center shaft 11, the handle portion 420 of the driving operation system 400 may be configured to extend downward from the connection portion 430.

Forming the rotation groove 120 at a position spaced upward or downward from the center shaft 11 may reduce interference between the display portion 300 and the driving operation system 400.

Furthermore, the handle portions 420, which extend upward or downward from the connection portion 430 of the driving operation system 400, may be disposed to be positioned on the right and left sides of the display portion 300, so that the ease of operation and visibility of the display portion 300 may improve.

To allow the driving operation system 400 to be inserted and concealed within the fixed housing 200 in the hidden state, the rotation groove 120, which allows the rotation of the driving operation system 400, may be formed in the rotation housing 100 at a position spaced upward from the center shaft 11, which passes through the center of the rotation housing 100.

The fixed housing 200 may include an operation system insertion portion 210 of a predetermined size, into which the driving operation system 400 is inserted in an autonomous driving mode. Connection grooves 220 may be formed on the right and left sides of the operation system insertion portion 210 to connect the operation system insertion portion 210 with the rotation groove 120.

The operation system insertion portion 210 may be formed of a size sufficient to allow the driving operation system 400 to be inserted and concealed in the hidden state.

The connection groove 220 may be formed to extend laterally from the right and left sides of the operation system insertion portion 210, which connects the operation system insertion portion 210 with the rotation groove 120.

During the rotation of the driving operation system 400 relative to the rotation housing 100, the connection groove 220, along with the rotation groove 120, is configured to allow the rotation of the driving operation system 400.

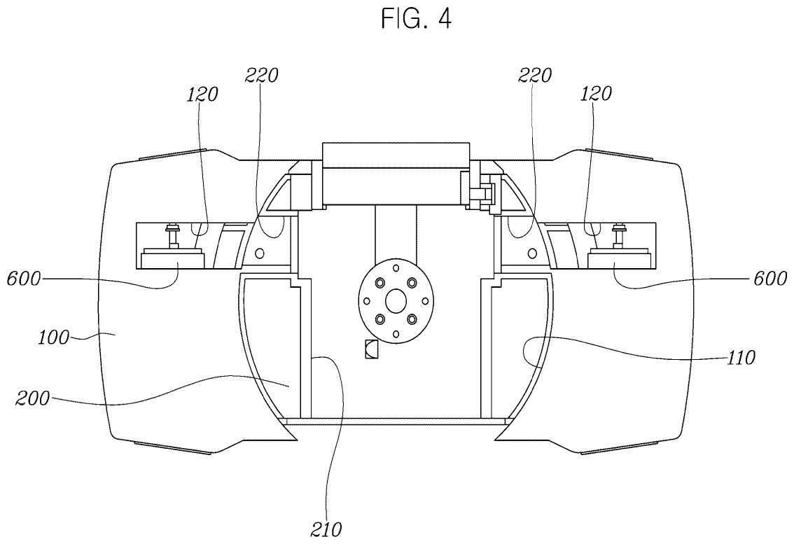

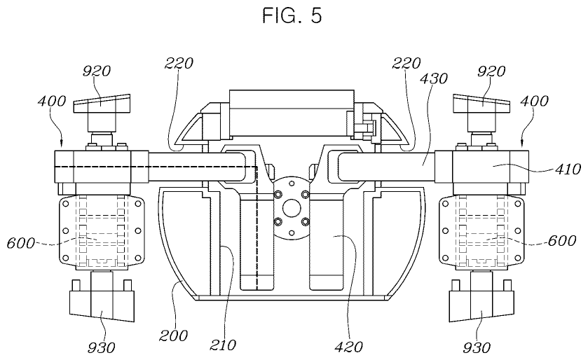

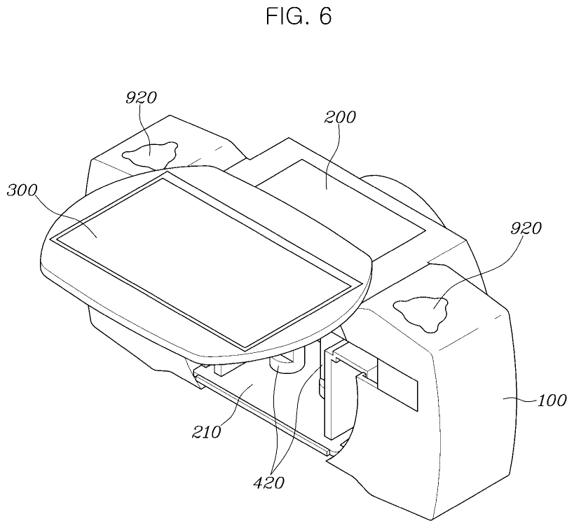

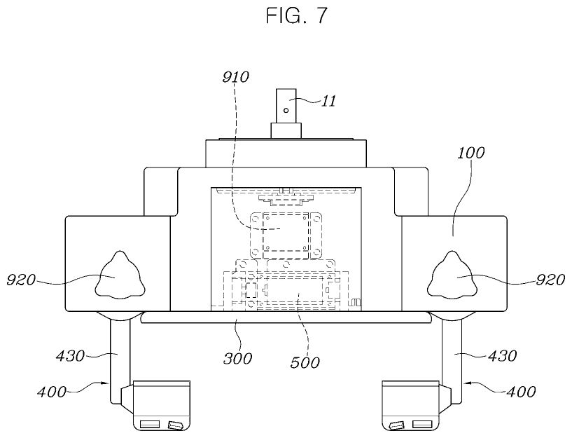

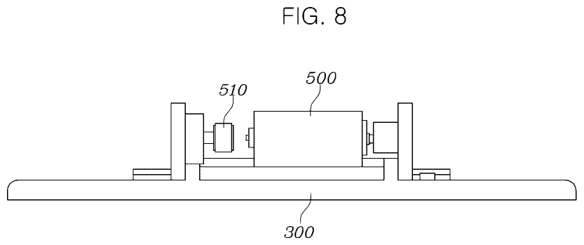

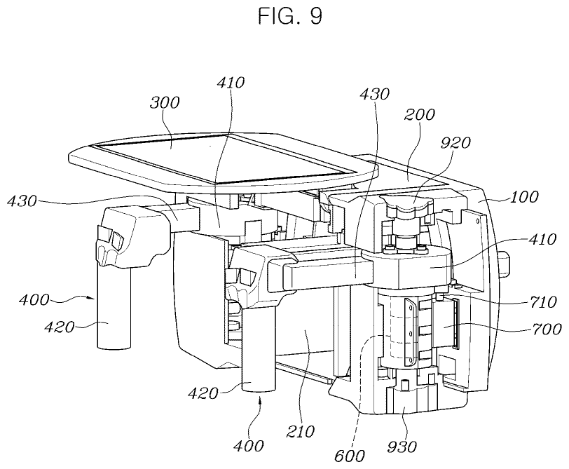

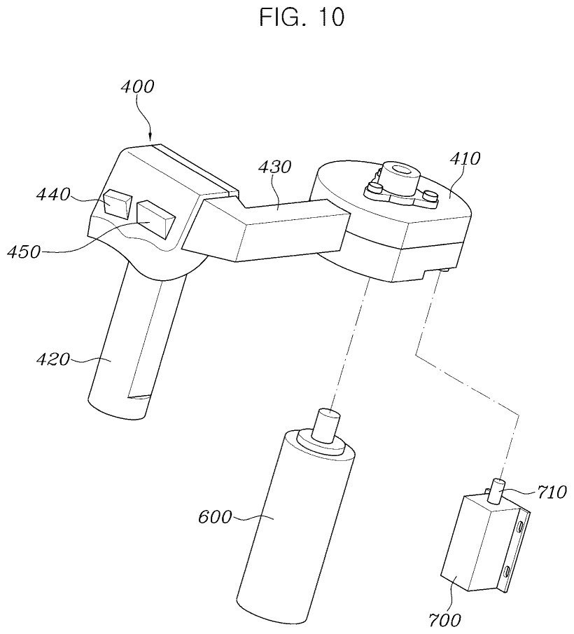

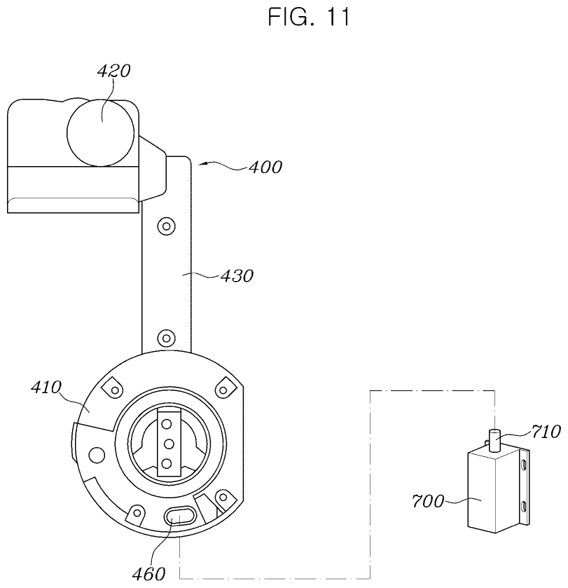

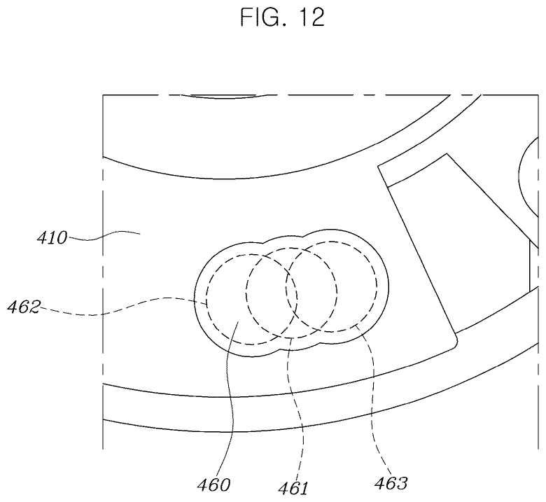

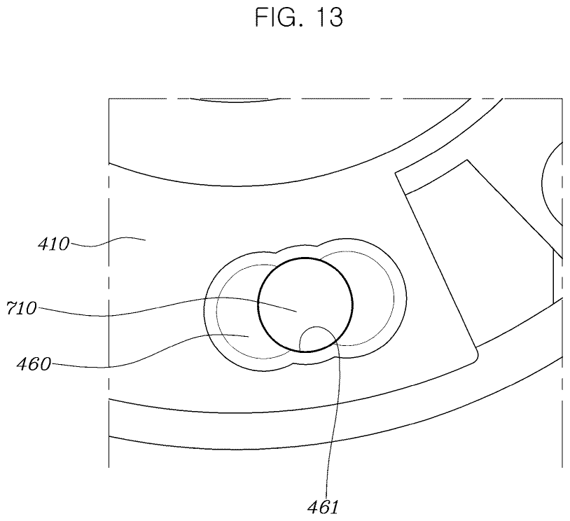

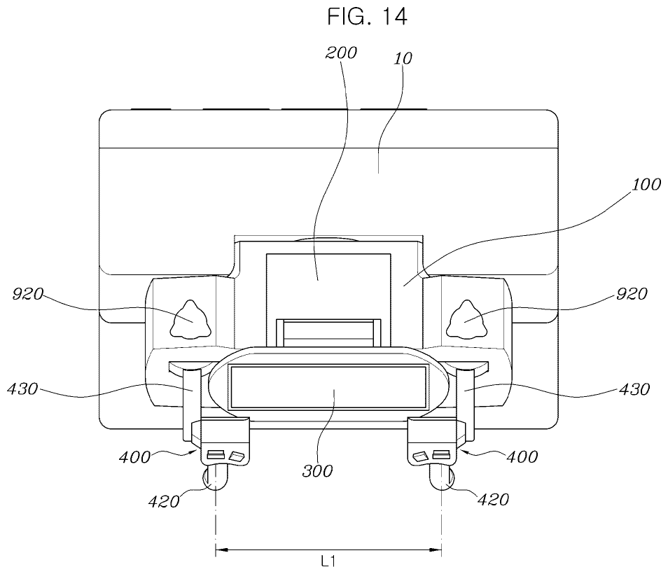

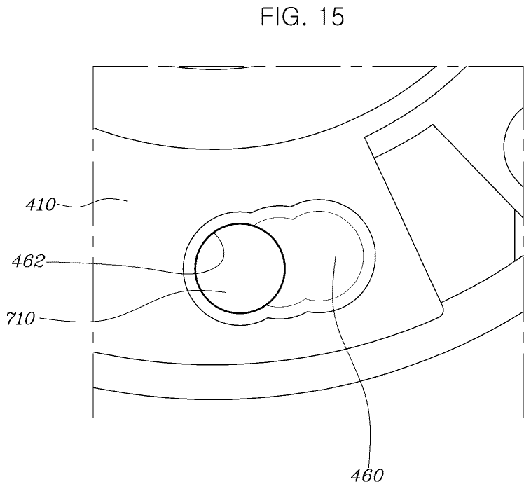

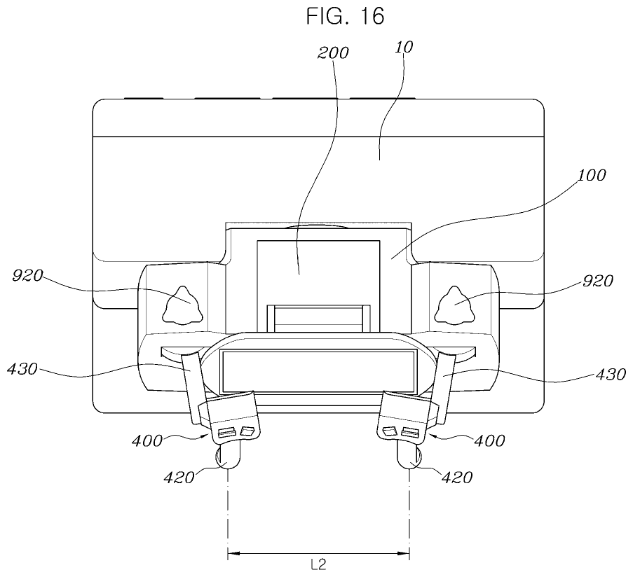

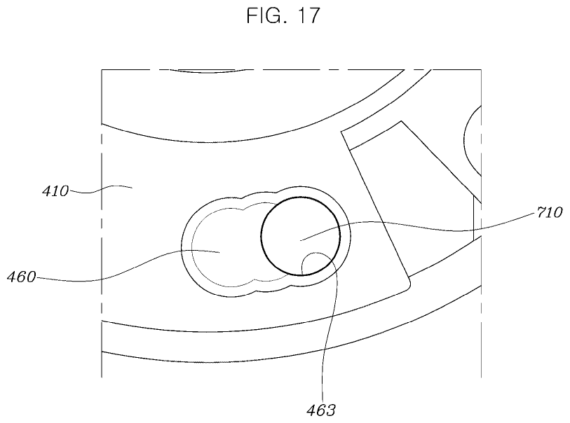

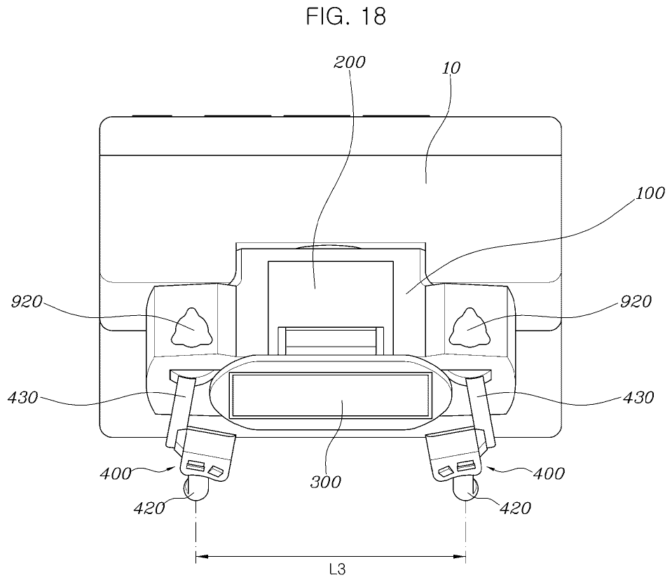

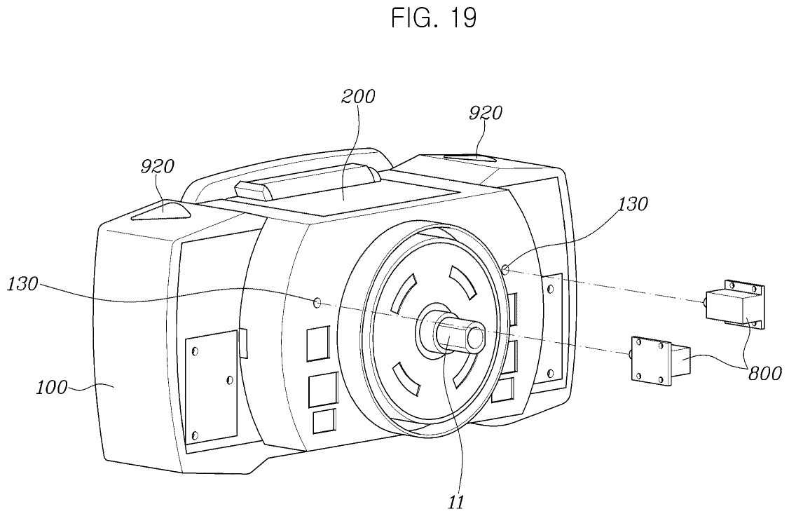

Referring to FIG. 5, in the hidden state that the driving operation system 400 is inserted into the operation system insertion portion 210, the driving operation system 400 may have an “L” shape. Referring to FIGS. 4 and 5, the operation system insertion portion 210 and the connection groove 220 formed in the fixed housing 200 may be connected in a “T” shape to allow the insertion of the driving operation system 400 in the hidden state.

The display portion 300 rotates vertically relative to the fixed housing 200. In response to the display portion 300 rotating upward, the operation system insertion portion 210 is opened, and in response to the display portion 300 rotating downward, the operation system insertion portion 210 may be closed by the display portion 300.

The rotation center may be positioned at the upper portion of the display portion 300, allowing the display portion 300 to rotate vertically relative to the fixed housing 200.

The display portion 300 may rotate relative to the fixed housing 200 to allow the hide or pop-up operation of the driving operation system 400 in the transition from an autonomous driving mode to a manual driving mode or from manual driving mode to autonomous driving mode.

If the rotation center is positioned at the lower portion of the display portion 300, and the display portion 300 is configured to rotate downward relative to the fixed housing 200 to open the operation system insertion portion 210, the downwardly rotating display portion 300 may come into contact with the driver's body (hand). In such a case, the rotation of the display portion 300 may not proceed smoothly, or the driver may experience discomfort.

Therefore, the display portion 300 may include the rotation center on the upper portion thereof, allowing for the vertical rotation relative to the fixed housing 200.

An exemplary embodiment of the present disclosure may further include a first motor 500 fixed to the fixed housing 200 and connected to the display portion 300 to enable power transmission. During the operation of the first motor 500, the display portion 300 may rotate vertically relative to the fixed housing 200.

The first motor 500 may be a unidirectional fixed motor with a motor shaft protruding in a single direction, or a bidirectional fixed motor with a motor shaft protruding in both directions.

In the case of a unidirectional fixed motor, the motor shaft is coupled to the display portion 300, and the opposite side may be connected to the upper portion of the fixed housing 200 via a bearing 510, allowing for easy assembly of the first motor 500.

In the case of a bidirectional fixed motor, the motor shaft, which protrudes in both directions, may be coupled to the display portion 300, allowing the power of the first motor 500 to be transmitted more reliably to the display portion 300. Compared to the structure of the unidirectional fixed motor, a simpler configuration may be achieved as there is no need to use a bearing.

An exemplary embodiment of the present disclosure may further include a second motor 600 fixed to the rotation housing 100 and connected to an end portion of the driving operation system 400 to enable power transmission. During the operation of the second motor 600, the driving operation system 400 may rotate and be hidden or popped up.

The second motor 600 may include two separate motors so that each is connected to one of the right and left driving operation systems 400.

The driving operation system 400 according to an exemplary embodiment of the present disclosure may include a body portion 410 at one end, positioned within the rotation housing 100 and coupled to the second motor 600, the handle portion 420 at the other end portion that the driver grips with a hand to perform steering operation by rotating the rotation housing 100 clockwise or counterclockwise, and the connection portion 430 that connects the body portion 410 and the handle portion 420.

The driver may rotate the rotation housing 100 clockwise and counterclockwise by gripping the handle portion 420 during steering operation. Therefore, the handle portion 420 is configured as a steering operation system.

The driving operation system 400 may further include an acceleration operation system 440 and a braking operation system 450, which are positioned between the handle portion 420 and the connection portion 430 and are operated by the driver.

For example, the acceleration operation system 440 and the braking operation system 450 may be configured as button switches that the driver operates by pressing with a finger.

The driver may operate the acceleration operation system 440 or the braking operation system 450 with a thumb in the state of gripping the handle portion 420.

The driving operation system 400 on the left and the driving operation system 400 on the right may each be provided with the handle portion 420 for steering operation, the acceleration operation system 440 for acceleration operation, and the braking operation system 450 for braking operation.

An exemplary embodiment of the present disclosure may further include a first solenoid 700 fixed to the rotation housing 100 and having a first rod 710 that moves back and forth during operation.

The first solenoid 700 may include two separate solenoids so that each is matched with one of the right and left driving operation systems 400.

The driving operation system 400 may be formed with a first stopper groove 460 into which the first rod 710 is inserted, and the first rod 710 may move forward in the popped-up state of the driving operation system 400 and be inserted into the first stopper groove 460. As the first rod 710 is inserted into the first stopper groove 460, the position of the driving operation system 400 is fixed in the popped-up state, which may limit rotation.

Following the complete pop-up of the driving operation system 400, the first solenoid 700 operates so that the first rod 710 is inserted into the first stopper groove 460. This may significantly enhance the strength and rigidity of the driving operation system 400. Accordingly, the driving operation system 400 may prevent any movement or rotation during vehicle driving.

The body portion 410 of the driving operation system 400, which faces the first solenoid 700 fixed to the rotation housing 100, may be formed with the first stopper groove 460.

In response to a signal generated for transition from manual driving mode to autonomous driving mode, the first rod 710 may move backward and detach from the first stopper groove 460, allowing the driving operation system 400 to rotate for the hide operation through the activation of the second motor 600.

Referring to FIG. 12, the first stopper groove 460 may include a first groove 461, a second groove 462, and a third groove 463, disposed to extend along the rotation direction of the driving operation system 400. The first groove 461 may be positioned in the center, and the second groove 462 and third groove 463 are positioned to the left and right of the first groove 461, respectively. The left and right sides of the first groove 461 may partially overlap with a side of the second groove 462 and a side of the third groove 463, respectively.

Referring to FIG. 12, the first groove 461 is positioned in the center, the second groove 462 is positioned to the left of the first groove 461, so that a portion of the left side of the first groove 461 overlaps with a portion of the right side of the second groove 462, and the third groove 463 is positioned to the right of the first groove 461, so that a portion of the right side of the first groove 461 overlaps with a portion of the left side of the third groove 463.

Therefore, as the right and left driving operation systems 400 rotate to narrow or widen the distance between the right and left handle portions 420 in the state where the first rod 710 of the first solenoid 700 is inserted into the first stopper groove 460, the first rod 710 may move along the first stopper groove 460 and be positioned in any one of the first groove 461, the second groove 462, or the third groove 463.

As shown in FIGS. 13 and 14, if the first rod 710 is inserted into the first groove 461, the connection portion 430 is configured to protrude perpendicularly from a surface of the display portion 300 in the popped-up right and left driving operation systems 400. In the instant state, the right and left handle portions 420 of the driving operation systems 400 may be spaced apart by a first distance L1.

As shown in FIGS. 15 and 16, if the first rod 710 is inserted into the second groove 462, the connection portion 430 is configured to protrude at an acute angle from a surface of the display portion 300 in the popped-up right and left driving operation systems 400. In the instant state, the right and left handle portions 420 of the driving operation systems 400 may be spaced apart by a second distance L2, which is narrower than the first distance L1.

As shown in FIGS. 17 and 18, if the first rod 710 is inserted into the third groove 463, the connection portion 430 is configured to protrude at an obtuse angle from a surface of the display portion 300 in the popped-up right and left driving operation systems 400. In the instant state, the right and left handle portions 420 of the driving operation systems 400 may be spaced apart by a third distance L3, which is wider than the first distance L1.

The vehicle mounting portion 10 may be provided with an arc seating portion 12 into which a portion of the rotation housing 100 is inserted and which allows clockwise and counterclockwise rotation of the rotation housing 100 during steering operation.

An exemplary embodiment of the present disclosure may further include a second solenoid 800, which is fixed to the arc seating portion 12 provided in the vehicle mounting portion 10 and includes a second rod 810 that moves back and forth during operation.

The second solenoid 800 may be configured with at least one solenoid, but is not limited to the present configuration.

A second stopper groove 130 may be formed in the rotation housing 100 at a position facing the second solenoid 800, and during the operation of the second solenoid 800, the second rod 810 may be inserted into the second stopper groove 130.

The second rod 810 may move forward and be inserted into the second stopper groove 130 in response to a signal generated for transition from an autonomous driving mode to a manual driving mode, and following the insertion of the second rod 810 into the second stopper groove 130, the operation of the second motor 600 may change the driving operation system 400 from the hidden state to the popped-up state.

Furthermore, in the state where the second rod 810 is inserted into the second stopper groove 130, the operation of the second motor 600 may change the driving operation system 400 from the hidden state to the popped-up state. In the instant state, the rotation housing 100 may have movement and rotation prevented by the support of the second rod 810 inserted into the second stopper groove 130, which enables an improvement in durability.

In response to the driving operation system 400 changing from the hidden state to the popped-up state and the transition to manual driving mode being complete, the second rod 810 may move backward and detach from the second stopper groove 130, and the rotation housing 100 may rotate clockwise or counterclockwise relative to the vehicle mounting portion 10 during steering operation.

Furthermore, in response to a signal generated for transition from manual driving mode to autonomous driving mode, the second rod 810 may move forward and be inserted into the second stopper groove 130, and following the insertion of the second rod 810 into the second stopper groove 130, the operation of the second motor 600 may cause the driving operation system 400 to change from the popped-up state to the hidden state, and following the completion of the transition to autonomous driving mode, the second rod 810 may either move backward to detach from the second stopper groove 130 or remain inserted within the second stopper groove 130.

Following the completion of the transition to autonomous driving mode, if the second rod 810 remains inserted within the second stopper groove 130, the power applied to the second solenoid 800 increases.

Therefore, if the spring force of the return spring provided in the rotation housing 100 is sufficient to prevent the movement of the rotation housing 100 in an autonomous driving mode, the second rod 810 may move backward and detach from the second stopper groove 130. However, this is not limited to such a configuration.

An exemplary embodiment of the present disclosure may further include an operation system control unit 910 disposed in the fixed housing 200, which controls the operation of the first motor 500, second motor 600, first solenoid 700, and second solenoid 800, and communicates signals related to steering, acceleration, braking, and gear shifting with a vehicle control unit 20.

The operation control unit 910 may be configured as a single unit or multiple units, and for example, may be configured as a printed circuit board (PCB) provided with a Hall sensor.

The display portion 300 may be provided with a gear shifting operation system that the driver operates by touching with a finger, and the gear shifting operation system may include a P switch, an R switch, an N switch, and a D switch.

The driver may perform steering operation by gripping the handle portion 420 of the driving operation system 400 and rotating the rotating housing 100 clockwise or counterclockwise.

The rotation housing 100 includes a permanent magnet, and in response to the rotation of the rotation housing 100 during steering operation, the operation system control unit 910 may detect the change in magnetic flux of the permanent magnet and generate signals related to the steering function.

The driver may operate the acceleration operation system 440 and the braking operation system 450, which are button-shaped, with a thumb in the state of holding the handle portion 420 of the driving operation system 400.

The acceleration operation system 440 and braking operation system 450 are each provided with a permanent magnet, and the operation of the acceleration operation system 440 or braking operation system 450 allows the operation system control unit 910 to detect the change in magnetic flux of the permanent magnet and generate signals related to the acceleration or braking function.

The signals related to steering, acceleration, braking, and gear shifting generated by the operation system control unit 910 may be transmitted to the vehicle control unit 20.

An exemplary embodiment of the present disclosure may further include an upper cover 920 and a lower cover 930 coupled to the rotation housing 100.

The upper cover 920 and the lower cover 930 may each be configured with two separate components.

The upper cover 920 may be coupled to the upper right and left sides of the rotation housing 100, thus preventing the body portion 410 of the driving operation system 400, positioned within the rotation housing 100, from being externally exposed of the rotation housing 100.

The lower cover 930 may be coupled to the lower right and left sides of the rotation housing 100, thus preventing the second motor 600, positioned within the rotation housing 100, from being exposed to the outside thereof.

Referring to FIG. 5, in the hidden state, the driving operation systems 400 may be disposed side by side on the right and left as viewed from the driver's side, and the connection portion 430 and the handle portion 420 may be configured to form an L-shape. The operation system insertion portion 210 and the connection groove 220, which are formed in the fixed housing 200 to allow the insertion of the right and left driving operation systems 400, may be configured to connect in a T-shape as viewed from the driver's side thereof.

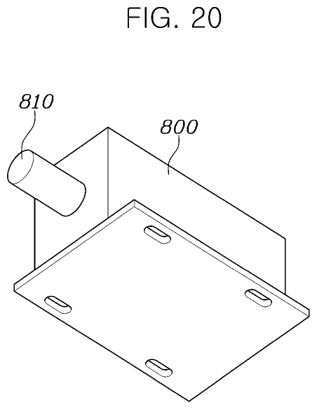

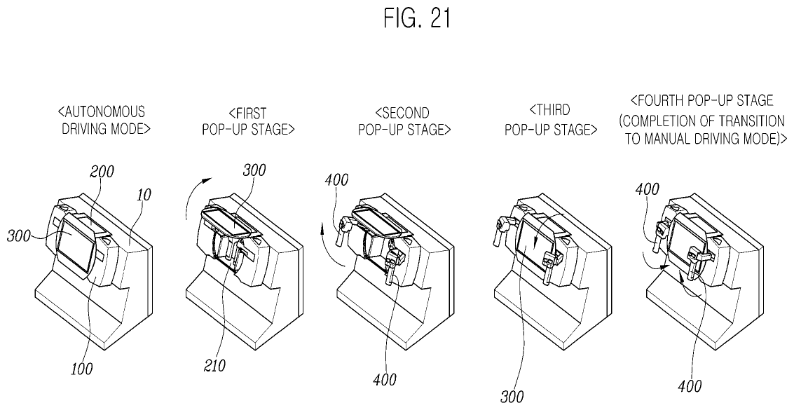

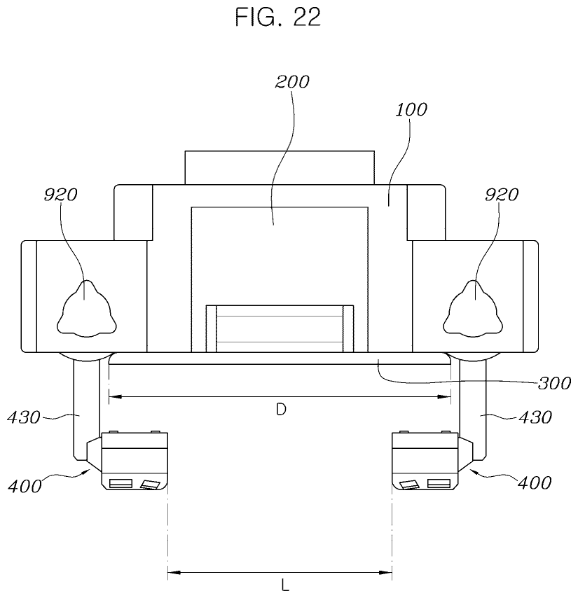

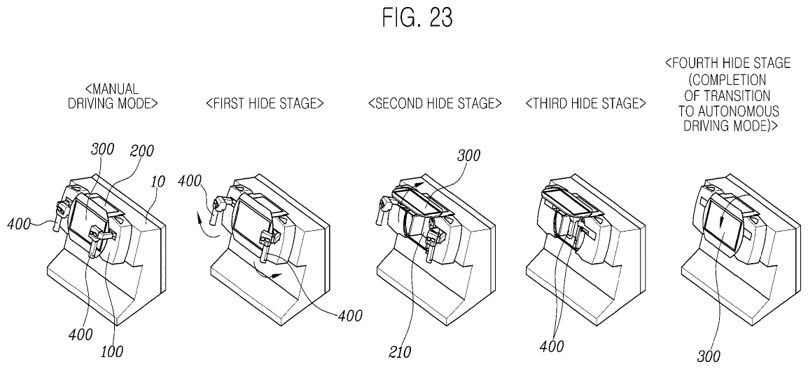

With reference to FIGS. 21 to 23, an operating method of a driving operation apparatus for a vehicle according to an exemplary embodiment of the present disclosure is described.

A larger display portion 300 provides better visibility for the driver and allows for more menu options and larger images.

An exemplary embodiment of the present disclosure is a method that enables effective pop-up and hide operations of the right and left driving operation systems 400 under the condition that a right-left width D of the display portion 300 is wider than a distance L between the right and left driving operation systems 400.

The operation process of the driving operation system 400 changing from the hidden state to the popped-up state in response to a signal generated for transition from an autonomous driving mode to a manual driving mode is illustrated in FIGS. 21 and 22.

As illustrated, an exemplary embodiment of the present disclosure may include a first pop-up stage in which in response to a signal generated for transition from an autonomous driving mode to a manual driving mode, the operation of the first motor 500 causes the display portion 300 to rotate upward relative to the fixed housing 200 and open the operation system insertion portion 210 of the fixed housing 200, a second pop-up stage in which following the completion of the first pop-up stage, the second motor 600 operates, and in response to the operation of the second motor 600, the right and left driving operation systems 400 positioned within the operation system insertion portion 210 rotate outward to the full extent of rotation, causing both operation systems to pop up, and the pop-up ends with the distance L between the right and left driving operation systems 400 becoming wider than the right-left width D of the display portion 300, a third pop-up stage in which following the completion of the second pop-up stage, the first motor 500 operates, and in response to the operation of the first motor 500, the display portion 300, rotated upward, rotates downward relative to the fixed housing 200 and closes the operation system insertion portion 210 of the fixed housing 200, and a fourth pop-up stage in which following the completion of the third pop-up stage, the second motor 600 operates, and in response to the operation of the second motor 600, the right and left driving operation systems 400, popped up by rotating to the full extent of rotation, rotate in the opposite direction to narrow the distance L between the driving operation systems 400, and a position adjustment to a suitable position for manual driving mode is completed.

In the second pop-up stage, both right and left driving operation systems 400 may rotate outward to the full extent of rotation to pop up, which prevents interference between the display portion 300 and the driving operation systems 400 during the rotation of the display portion 300 in the third pop-up stage. This allows for the installation of a larger display portion 300.

For example, if the position of the driving operation systems 400, popped up by rotating to the full extent of rotation in the second pop-up stage, is the same as the position of the driving operation systems 400 that the position adjustment to a suitable position for manual driving mode is completed in the fourth pop-up stage, the fourth pop-up stage may be omitted, and the pop-up operation may be completed in the third pop-up stage.

Following the completion of the fourth pop-up stage, the operation of the second motor 600 allows for further adjustment of the distance L between the driving operation systems 400, either in the direction of narrowing or widening, enabling fine-tuning the position of the driving operation systems 400.

The operation process of the driving operation system 400 changing from the popped-up state to the hidden state in response to a signal generated for transition from manual driving mode to autonomous driving mode is illustrated in FIG. 23.

An exemplary embodiment of the present disclosure may include a first hide stage in which following the completion of the third pop-up stage, the second motor 600 operates in response to a signal generated for transition from manual driving mode to autonomous driving mode, and the operation of the second motor 600 causes both the right and left driving operation systems 400, in the popped-up state, to rotate outward to the full extent of rotation, and the distance L between the right and left driving operation systems 400, rotated outward to the full extent of rotation, becomes wider than the right-left width D of the display portion 300, a second hide stage in which following the completion of the first hide stage, the operation of the first motor 500 causes the display portion 300 to rotate upward relative to the fixed housing 200 and open the operation system insertion portion 210 of the fixed housing 200, a third hide stage in which following the completion of the second hide stage, the second motor 600 operates, and in response to the operation of the second motor 600, both the right and left driving operation systems 400, in the popped-up state, rotate inward and are inserted into the operation system insertion portion 210, and a fourth hide stage in which following the completion of the third hide stage, the first motor 500 operates, and in response to the operation of the first motor 500, the display portion 300, rotated upward, rotates downward relative to the fixed housing 200 and closes the operation system insertion portion 210 of the fixed housing 200.

In the first hide stage, both right and left driving operation systems 400 may rotate outward to the full extent of rotation, which prevents interference between the display portion 300 and the driving operation systems 400 during the rotation of the display portion 300 in the second hide stage. This allows for the installation of a larger display portion 300.

As described above, the driving operation apparatus for a vehicle and the operating method thereof according to an exemplary embodiment of the present disclosure provide a modular configuration in which the driving operation system 400 for steering, acceleration, and braking is integrated with the display portion 300 into a single system. This contributes to weight reduction and cost savings by reducing the number of components, and allows for the compact layout required for installation space, enabling greater efficiency in utilizing the internal space.

The present disclosure provides a configuration allowing the driving operation system 400 for steering, acceleration, and braking to be hidden in an autonomous driving mode, which prevents operation by the driver, and to be popped up in a manual driving mode, which enables operation by the driver. The present configuration allows comfortable rest for the driver in autonomous driving situations and improves safety by preventing accidental operation.

Furthermore, the present disclosure includes an integrated display that delivers enhanced entertainment for passengers in an autonomous driving mode and provides vehicle and environmental information in a manual driving mode, which improves convenience and safety.

Although the specific embodiments of the present disclosure have been described and illustrated, those skilled in the art will appreciate that various alternations and modifications are possible without departing from the technical spirit of the present disclosure provided in the appended claims.

What is claimed is:

1. A driving operation apparatus for a vehicle, the driving operation apparatus comprising:
a rotation housing, wherein a center shaft fixed to a vehicle mounting portion passes through the rotation housing and the rotation housing is configured to rotate about the center shaft during steering operation;
a fixed housing coupled to and fixed with the center shaft;
a display portion coupled to the fixed housing; and
a pair of driving operation systems rotatably disposed relative to the rotation housing and configured to be inserted and concealed within the fixed housing through a hide operation in an autonomous driving mode, and protrude toward a driver from right and left sides of the display portion through a pop-up operation in a manual driving mode, which enables steering, acceleration, and braking operations by the driver in a popped-up state.

2. The driving operation apparatus of claim 1, further comprising:
a housing insertion portion disposed in a center portion of the rotation housing, wherein the fixed housing is inserted into the housing insertion portion and coupled with the center shaft.

3. The driving operation apparatus of claim 2,
wherein the rotation housing includes rotation grooves that allow a rotation of the driving operation systems and are connected to the housing insertion portion on right and left sides of the housing insertion portion, and
wherein the rotation grooves are formed at a position spaced in a first direction or in a second direction from the center shaft.

4. The driving operation apparatus of claim 3,
wherein the fixed housing includes an operation system insertion portion into which the driving operation systems are inserted in the autonomous driving mode, and
wherein connection grooves are formed on the right and left sides of the operation system insertion portion to connect the operation system insertion portion with the rotation grooves.

5. The driving operation apparatus of claim 4,
wherein the display portion is configured to rotate vertically relative to the fixed housing, and
in response to the display portion rotating in the first direction, the operation system insertion portion is opened, and in response to the display portion rotating in the second direction, the operation system insertion portion is closed by the display portion.

6. The driving operation apparatus of claim 4, further comprising:
a first motor fixed to the fixed housing and connected to the display portion to enable power transmission,
wherein in response to an operation of the first motor, the display portion rotates vertically relative to the fixed housing.

7. The driving operation apparatus of claim 6, further comprising:
a second motor fixed to the rotation housing and connected to an end portion of the driving operation systems to enable power transmission,
wherein in response to an operation of the second motor, the driving operation systems rotate to be hidden or popped up.

8. The driving operation apparatus of claim 7, wherein each driving operation system includes:
a body portion at an end, which is positioned within the rotation housing and coupled with the second motor;
a handle portion at an opposite end portion that the driver grips with a hand to perform the steering operation by rotating the rotation housing clockwise or counterclockwise; and
a connection portion connecting the body portion and the handle portion,
wherein the handle portion is configured to protrude toward the driver in the pop-up operation.

9. The driving operation apparatus of claim 8, wherein each driving operation system further includes an acceleration operation system and a braking operation system, which are positioned between the handle portion and the connection portion and are driven in response to the driver's operation.

10. The driving operation apparatus of claim 8, further comprising:
a first solenoid fixed to the rotation housing and having a first rod that moves back and forth during operation thereof,
wherein each driving operation system is formed with a first stopper groove into which the first rod is inserted,
wherein the first rod moves forward and is inserted into the first stopper groove in a state where the driving operation systems are popped up, and
wherein in response to an insertion of the first rod into the first stopper groove, a position of the driving operation systems is fixed in the popped-up state, thus restricting rotation.

11. The driving operation apparatus of claim 10, wherein the first stopper groove includes a first groove, a second groove, and a third groove, disposed to extend along a rotation direction of the driving operation systems,
wherein the first groove is positioned in a center, and the second groove and the third groove are positioned to left and right sides of the first groove, and the left and right sides of the first groove are partially overlapped with a side of the second groove and a side of the third groove, respectively.

12. The driving operation apparatus of claim 11, wherein in response to the insertion of the first rod into the first groove, the popped-up right and left driving operation systems have the connection portion protruding perpendicularly from a surface of the display portion, and the right and left handle portions are spaced by a first distance,
in response to an insertion of the first rod into the second groove, the popped-up right and left driving operation systems have the connection portion protruding at an acute angle from the surface of the display portion, and the right and left handle portions are spaced by a second distance, narrower than the first distance, and
in response to an insertion of the first rod into the third groove, the popped-up right and left driving operation systems have the connection portion protruding at an obtuse angle from the surface of the display portion, and the right and left handle portions are spaced by a third distance, wider than the first distance.

13. The driving operation apparatus of claim 10,
wherein the vehicle mounting portion includes an arc seating portion into which a portion of the rotation housing is inserted and which allows clockwise and counterclockwise rotation of the rotation housing during the steering operation, and
wherein the driving operation apparatus further includes a second solenoid fixed to the arc seating portion and having a second rod that moves back and forth during operation thereof,
wherein the rotation housing includes a second stopper groove into which the second rod is inserted,
wherein the second rod moves forward and is inserted into the second stopper groove in response to a signal generated for transition from the autonomous driving mode to the manual driving mode, and
wherein following an insertion of the second rod into the second stopper groove, an operation of the second motor causes the driving operation systems to change from a hidden state to the popped-up state.

14. The driving operation apparatus of claim 8,
wherein the driving operation systems are disposed side by side on the right and left as viewed from the driver's side in a hidden state, and the connection portion and the handle portion are configured to form an L-shape, and
wherein the operation system insertion portion and the connection groove, which are formed in the fixed housing to allow an insertion of the right and left driving operation systems, are configured to connect in a T-shape as viewed from the driver's side.

15. The driving operation apparatus of claim 13, wherein in response to the driving operation systems changing from the hidden state to the popped-up state and a transition to the manual driving mode being complete, the second rod moves backward and detaches from the second stopper groove, and the rotation housing rotates clockwise or counterclockwise relative to the vehicle mounting portion during the steering operation.

16. The driving operation apparatus of claim 13, wherein the second rod moves forward and is inserted into the second stopper groove in response to a signal generated for transition from the manual driving mode to the autonomous driving mode, and
following an insertion of the second rod into the second stopper groove, an operation of the second motor causes the driving operation systems to change from the popped-up state to the hidden state, and in response to a completion of a transition to the autonomous driving mode, the second rod either moves backward to detach from the second stopper groove or remains inserted within the second stopper groove.

17. The driving operation apparatus of claim 13, further comprising:
an operation system control unit, which is disposed in the fixed housing, is configured to control an operation of the first motor, the second motor, the first solenoid, and the second solenoid, and communicates signals related to steering, acceleration, braking, and gear shifting with a vehicle control unit.

18. An operating method of a driving operation apparatus for a vehicle, the operating method comprising:
a first pop-up stage, wherein in response to a signal generated for transition from an autonomous driving mode to a manual driving mode, an operation of a first motor causes a display portion to rotate in a first direction relative to a fixed housing and open an operation system insertion portion of the fixed housing;
a second pop-up stage, wherein following a completion of the first pop-up stage, a second motor operates, and in response to an operation of the second motor, right and left driving operation systems positioned within the operation system insertion portion rotate outward to full extent of rotation, which causes the driving operation systems to pop up, and the pop-up ends with a distance between the right and left driving operation systems becoming wider than a right-left width of the display portion;
a third pop-up stage, wherein following a completion of the second pop-up stage, the first motor operates, and in response to the operation of the first motor, the display portion, rotated in the first direction, rotates in a second direction relative to the fixed housing and closes the operation system insertion portion of the fixed housing; and
a fourth pop-up stage, wherein following a completion of the third pop-up stage, the second motor operates, and in response to the operation of the second motor, the right and left driving operation systems, popped up by rotating to the full extent of rotation, rotate in an opposite direction to narrow the distance between the driving operation systems, and a position adjustment to a position for the manual driving mode is completed.

19. The operating method of claim 18, wherein following a completion of the fourth pop-up stage, the operation of the second motor allows for further adjustment of the distance between the driving operation systems, either in a direction of widening or narrowing.

20. The operating method of claim 18, further comprising:
a first hide stage, wherein following the completion of the third pop-up stage, the second motor operates in response to a signal generated for transition from the manual driving mode to the autonomous driving mode, and the operation of the second motor causes the right and left driving operation systems, in the popped-up state, to rotate outward to the full extent of rotation, and the distance between the right and left driving operation systems, rotated outward to the full extent of rotation, becomes wider than a right-left width of the display portion;
a second hide stage, wherein following a completion of the first hide stage, an operation of the first motor causes the display portion to rotate in the first direction relative to the fixed housing and open the operation system insertion portion of the fixed housing;
a third hide stage, wherein following a completion of the second hide stage, the second motor operates, and in response to the operation of the second motor, the right and left driving operation systems, in the popped-up state, rotate inward and are inserted into the operation system insertion portion; and
a fourth hide stage, wherein following a completion of the third hide stage, the first motor operates, and in response to the operation of the first motor, the display portion, rotated in the first direction, rotates in the second direction relative to the fixed housing and closes the operation system insertion portion of the fixed housing.
